(19) United States
(12) Patent Application Publication
(10) Pub. No.: US 2017/0028331 A1
(43) Pub. Date: Feb. 2, 2017

(54) Filter System With Integral On Board Compressed Air Generator

(71) Applicant: RoboVent Products Group, Inc., Sterling Heights, MI (US)

(72) Inventors: John Reid, Royal Oak, MI (US); Andrew Reid, Royal Oak, MI (US); Michael Hattingh, Troy, MI (US)

(21) Appl. No.: 15/221,684

(22) Filed: Jul. 28, 2016

Related U.S. Application Data
(60) Provisional application No. 62/197,601, filed on Jul. 28, 2015.

(51) Int. Cl. B01D 46/00; B01D 46/24; B23K 9/32; F24F 13/20; F24F 13/28

(52) U.S. Cl. CPC B01D 46/0068; F24F 13/20; F24F 13/28; B23K 9/32; B01D 46/24; B01D 46/002; F24F 2221/22; B01D 2279/50

(57) ABSTRACT

An air filter system for use in industrial applications, particularly, in welding operations. The system has a fan for drawing air into a housing and an air outlet for exhausting air from the housing. At least one filter is mounted within the housing between the air inlet and the air outlet. Air is passed through the filter as it is drawn into the inlet and exhausted from the outlet to retain particulates entrained in the air. At least one air injector is mounted adjacent the filter to clean the filter by forcing air into the filter to remove the retained particulate from the filter. An onboard compressed air generator is mounted within the housing to supply compressed air to the air injector for injection into the filter.

### CROSS REFERENCE APPLICATION

This application claims the benefit of U.S. Provisional Application No. 62/197,601 filed on Jul. 28, 2015, and is hereby incorporated therein.

### FIELD OF THE INVENTION

### Background

Air filtering units are commonly used in manufacturing processes. One typical application is to filter the air within a welding station. Typically a conduit is connected between an opening in the welding station and the air filtering unit. During operation of the air filtering unit, the air within the welding station is drawn from the welding station, through the conduit and into the filtering unit by a blower fan. A plurality of filters is mounted in the filtering unit and the air from the welding station is pulled through the filters. The filters extract the particulate from the air and then the air is expelled from the filter unit back into the surrounding environment.

Over time, the filters become dirty with particulate and require cleaning. The air filtering units generally have reverse pulse cleaners. In a reverse pulse system, air injectors are traditionally positioned adjacent to each of the filters. The air injectors are supplied with compressed air. The compressed air is provided by compressed air generators within the facility. These compressed air generators are the same generators that supply compressed air to other tools and operations within the facility.

When it is time to clean the filters, all of the air injectors are simultaneously actuated forcing compressed air into and through the filters, from the inside to the outside, for the purpose of discharging any particulates that have accumulated on the filters. Generally, the compressed air released from the air injectors discharges particulate from the filter medium and the discharged particulates fall into a collector unit disposed below the filters. During total shutdown, a large amount of the particulate that has accumulated on the filters can be forced out of the filters.

The typical reverse pulse dust collector used in industry relies upon compressed air that is piped through an airline from a compressed air supply, generated by an external source. The compressed air is used in the filter cleaning system, which directs blasts of compressed air to the inside of the cartridge filters to clean off collected dust and reduce resistance to airflow drawn by the air filtering system.

Externally supplied compressed air can be the source of multiple issues in the operation of the air filtering system.

One problem is that oil and moisture present in the plant's compressed air system can make its way into the air filtering system causing damage and component break-down in the solenoid valves, and clog and bind the filter media of the filter cartridges.

Another problem is reliance on an external source of compressed air. For effective operation, the compressed air needs to be at the correct pressure and volume. Since the source of the compressed air is used for other purposes, the supply has the potential to be intermittent or interrupted, or have insufficient or incorrect pressure.

A further problem is that the existing compressors in the plant's compressed air system may not have sufficient capacity to accommodate additional air filtering systems that need to be added overtime.

There are also problems with air filtering systems that are installed outside the plant. The compressed air inside the plant may have a dew point of 40° F. for example, but when the pipe runs outside to the air filtering unit, it comes into contact with temperatures which are often below freezing in the winter months, which causes the moisture in the air to freeze in the pipe, causing restriction and blockages.

The present invention overcomes these problems by providing an air filtering unit with an onboard air compressor and storage tank system.

### BRIEF DESCRIPTION OF THE DRAWINGS

FIG. 1 is a partial side view of an air filtering system of the present invention.

FIG. 2 is a schematic view of the invention of the present invention.

### DETAILED DESCRIPTION OF THE INVENTION

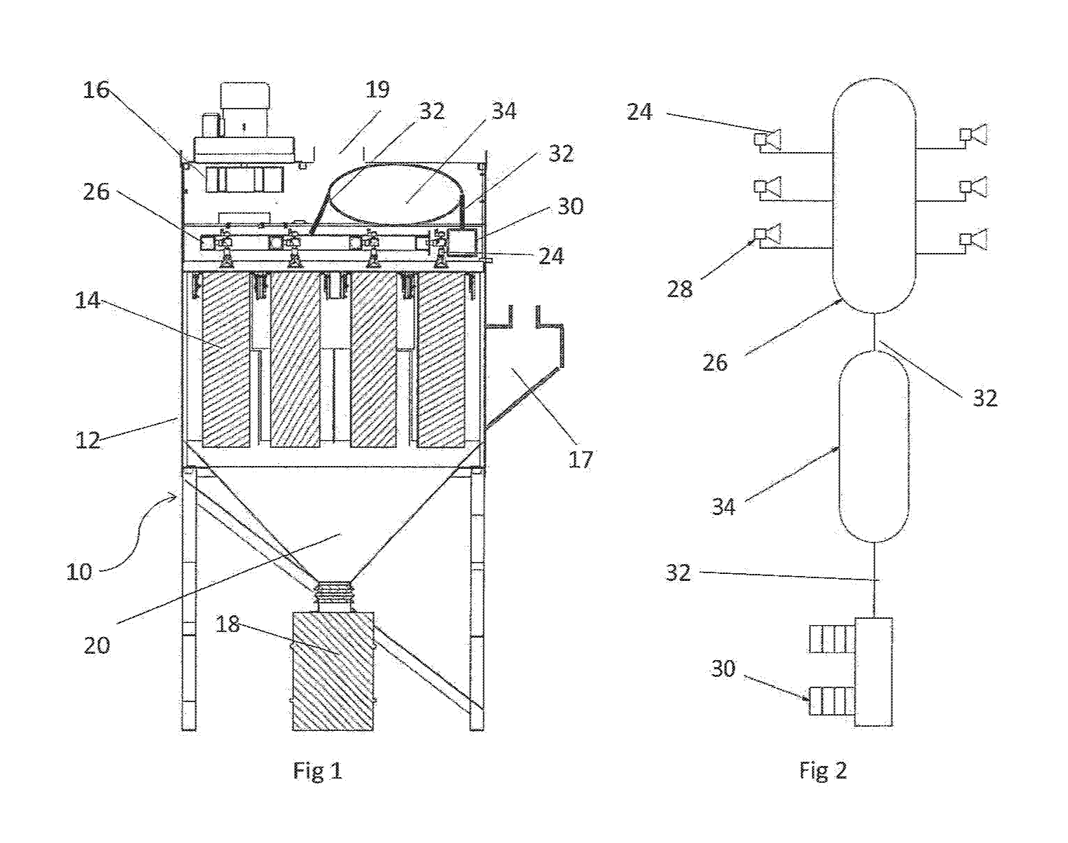

With reference to FIG. 1, an example of the air filtering system of the present invention is shown generally at 10. The system 10 includes a housing 12 enclosing at least one and preferably a plurality of filters 14 to filter air drawn into the housing 12 by a fan unit 16. The filters 14 are of traditional construction, and as disclosed are elongated cylinders, but could be any type of filter known to those of ordinary skill in the art.

The fan unit 16 draws air into the housing 12 through a fluid connection to the area to be filtered, such as for example a welding center. Air is pulled from the welding station into an inlet plenum 17, through the filters 14 and then through the fan unit 16 expelled through an outlet plenum 19 as filtered air.

The disclosed filters 14 are disclosed as cylinders and have a hollow core and the filter material surrounds the hollow core. As the air is drawn into and through the housing 12, the air is drawn into the hollow core of filter 12 and through the surrounding filter medium.

As illustrated, air injectors 24 are positioned over the hollow cores of each of the filters 14. Air injectors 24 are supplied with compressed air from the onboard compressed air generator 30. The air injectors 24 are used to clean the filters 14. Upon actuation of the air injectors 24, compressed air is forced into the hollow cores of the filters 14 to force air through the filters 14 from the inside to the outside for the purpose of forcing particulates on the filters 14 to be discharged from the filters into the collector hopper 20 and then to container 18.

The compact portable air compressor unit 30 is mounted inside the air filtering system 10. The compressor 30 is piped through airlines 32 to the pulse valve header tank 26. An additional auxiliary air tank 34 can also be added to the system when needed to provide additional compressed air reserves. The auxiliary tank 34 reduces the pressure drop that may occur when the injectors are activated. The pulsing of the injectors 24 can rapidly deplete the air pressure in the header tank 26. The use of the auxiliary tank 34 reduces this depletion and assists the compressor unit 30 to replenish the air and pressure lost through the pulsing.

The header tank 26 and auxiliary tank 34 (when equipped) provides a supply of compressed air, and the compressor 30 runs to build pressure back up after a solenoid valve 28 has activated to discharge a blast of compressed air to clean a filter. The pulsing interval is programmed at a specific time delay to match the capacity of the air compressor 30. The internal air compressor 30 is controlled by a pressure switch which turns the compressor 30 on when pressure drops below a set point, and then back off again when pressure exceeds another set point. In the disclosed embodiment, the compressor 30 is an electric compressor, but other types of compressors could be used.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. An air filter system comprising:
a housing;
an air inlet for drawing air into said housing and an air outlet for exhausting air from said housing;
a fan operatively connected to said housing for drawing air into said air inlet and exhausting air from said outlet;
at least one filter mounted within said housing between said air inlet and said air outlet, said air passing through said filter as it is drawn into said inlet and exhausted from said outlet;
said filter retaining particulate entrained in said air;
at least one air injector mounted adjacent said filter to clean said filter by forcing air into said filter to remove said retained particulate from said filter;
an onboard compressed air generator mounted within said housing supplying compressed air to said air injector for injection into said filter through said air injector.

2. The filter system of claim 1, further including a plurality of filters mounted within said housing.

3. The air filter system of claim 2, further including a plurality of air injectors, each one of said air injectors being operatively positioned adjacent a respective one of said filters.

4. The air filter system of claim 1, wherein said at least one filter has an open central longitudinally extending core, said injector being mounted adjacent said core for in injecting air into said core.

5. The air filter system of claim 1, further including piping directly connecting said on board compressed air generator directly to said air injector.

6. The air filter system of claim 1, further including a solenoid valve operatively connected to said air injector, said solenoid valve controlling the operation of said air injector.

7. The air filter system of claim 1, further including a compressed air storage tank for maintaining a quantity of compressed air on board said air filter system, said quantity of compressed air being generated by said on board compressed air generator.
